(19) United States
(12) Patent Application Publication
(10) Pub. No.: US 2025/0386007 A1
(43) Pub. Date: Dec. 18, 2025

(54) Methods and Apparatus for Video Coding Using Multiple History-Based Motion Vector Prediction Tables

(71) Applicant: MEDIATEK INC., Hsinchu City (TW)

(72) Inventors: Chen-Yen LAI, Hsinchu City (TW); Tzu-Der CHUANG, Hsinchu City (TW); Ching-Yeh CHEN, Hsinchu City (TW); Chih-Wei HSU, Hsinchu City (TW)

(21) Appl. No.: 18/876,387

(22) PCT Filed: May 24, 2023
(86) PCT No.: PCT/CN2023/096043

§ 371 Date: Dec. 18, 2024

Related U.S. Application Data
(60) Provisional application No. 63/354,801, filed on Jun. 23, 2022.

(51) Int. Cl. H04N 19/105; H04N 19/137; H04N 19/176

(52) U.S. Cl. CPC H04N 19/105; H04N 19/137; H04N 19/176

(57) ABSTRACT

Methods for video coding using multiple History-based MVP tables. According to one method, motion information for the current block is derived from the coded data at a decoder according to Merge candidate list or an AMVP (MVP (Adaptive Motion Vector Prediction)) list. The multi-HMVP MVP tables are updated according to the motion information derived for the current block. The Merge candidate list or the AMVP list is updated by inserting one or more MVP candidates from the multi-HMVP MVP tables. According to another method, the multiple HMVP lookup tables are updated according to the motion information derived for the current block, and the multiple HMVP lookup tables are updated according to different updating rules.

### CROSS REFERENCE TO RELATED APPLICATIONS

The present invention is a non-Provisional Application of and claims priority to U.S. Provisional Patent Application No. 63/354,801, filed on Jun. 23, 2022. The U.S. Provisional Patent Application is hereby incorporated by reference in its entirety.

### FIELD OF THE INVENTION

The present invention relates to inter prediction for video coding. In particular, the present invention relates to using multiple History-based MVP tables for inter prediction.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

In the present invention, methods and apparatus for video coding using multiple history-based MVP (Motion Vector Prediction) tables are disclosed to improve performance.

### BRIEF SUMMARY OF THE INVENTION

A method for video coding using multiple History-based MVP tables is disclosed. According to the method for a decoder side, coded data associated with a current block to be decoded are received. Motion information for the current block is derived from the coded data according to Merge candidate list or an AMVP (MVP (Adaptive Motion Vector Prediction)) list, wherein the Merge candidate list or the AMVP list comprises at least one MVP candidate from multi-HMVP (History-based MVP) MVP tables. The multi-HMVP MVP tables are updated according to the motion information derived for the current block. Furthermore, the Merge candidate list or the AMVP list is updated by inserting one or more MVP candidates from the multi-HMVP MVP tables.

In one embodiment, a position of the current block is also stored in the multi-HMVP MVP tables. For example, the position of the current block corresponds to a top-left position.

In one embodiment, an order to insert a target MVP candidate into the Merge candidate list or the AMVP list depends on a distance between the current block and a corresponding block associated with the target MVP candidate. For example, a first MVP candidate in the multi-HMVP MVP tables is selected to be inserted into the Merge candidate list or the AMVP list before a second MVP candidate if a first CU corresponding to the first MVP candidate is closer to the current block than a second CU corresponding to the second MVP candidate. In another example, a first MVP candidate in the multi-HMVP MVP tables is selected to be inserted into the Merge candidate list or the AMVP list before a second MVP candidate if a first CU corresponding to the first MVP candidate is farther to the current block than a second CU corresponding to the second MVP candidate. In yet another example, a first MVP candidate in the multi-HMVP MVP tables having a first distance between a first corresponding block of the first MVP candidate and the current block larger than a block width or a block height, but less than twice the block width or twice the block height is selected to be inserted into the Merge candidate list or the AMVP list first. Furthermore, a second MVP candidate in the multi-HMVP MVP tables having a second distance between a second corresponding block of the second MVP candidate and the current block larger than twice the block width or twice block height, but less than three times the block width or three times the block height is selected to be inserted into the Merge candidate list or the AMVP list second.

In one example, multiple MVP candidates from one table of the multi-HMVP MVP tables are inserted into the Merge candidate list or the AMVP list in an order from new to old, or from old to new. In yet another example, multiple MVP candidates from the multi-HMVP MVP tables are inserted into the Merge candidate list or the AMVP list in an interleaving manner.

A method for a corresponding encoder is also disclosed. At the encoder side, pixel data associated with a current block are received. Motion information for the current block is derived. The motion information for the current block is encoded using information comprising a Merge candidate list or an AMVP (MVP (Adaptive Motion Vector Prediction)) list, wherein the Merge candidate list or the AMVP list comprises at least one MVP candidate from multi-HMVP (History-based MVP) MVP tables. The multi-HMVP MVP tables is updated according to the motion information for the current block.

Another method for video coding using multiple History-based MVP tables is disclosed. According to this method at a decoder side, motion information for the current block is derived from the coded data according to multiple HMVP (History-based MVP) lookup tables. The multiple HMVP lookup tables are updated according to the motion information derived for the current block, and wherein the multiple HMVP lookup tables are updated according to different updating rules.

In one embodiment, the multiple HMVP lookup tables have different updating frequencies. In another embodiment, one of the multiple HMVP lookup tables is updated according quadtree depth, binary tree depth or a number of partitions associated with the current block. In yet another embodiment, whether a motion vector is used to update one of the multiple HMVP lookup tables depends on motion vector differences between the motion vector and motion vector candidates in said one of the multiple HMVP lookup tables.

In one embodiment, whether a motion vector is used to update one of the multiple HMVP lookup tables depends on a position of a corresponding block associated with the motion vector. In one embodiment, the position of the corresponding block corresponds to a top-left position. In another embodiment, if the position of the corresponding block is at a selected grid, the motion vector is used to update said one of the multiple HMVP lookup tables.

A method for a corresponding encoder is also disclosed. At the encoder side, the motion information for the current block is encoded using information comprising multiple HMVP (History-based MVP) lookup tables. The multiple HMVP lookup tables are updated according to the motion information derived for the current block, and wherein the multiple HMVP lookup tables are updated according to different updating rules.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates an exemplary process flow for a decoder incorporating History-based MVP candidate list.

FIG. 3A illustrates an example of updating the HMVP table using FIFO (First-In-First-Out) structure.

FIG. 3B illustrates an example of updating the HMVP table using constrained FIFO (First-In-First-Out) structure.

FIG. 4 illustrates a flowchart of an exemplary video decoding system that incorporates multiple History-based MVP tables according to one embodiment of the present invention.

FIG. 5 illustrates a flowchart of an exemplary video encoding system that incorporates multiple History-based MVP tables according to one embodiment of the present invention.

FIG. 6 illustrates a flowchart of another exemplary video decoding system that incorporates multiple History-based MVP tables according to one embodiment of the present invention.

FIG. 7 illustrates a flowchart of another exemplary video encoding system that incorporates multiple History-based MVP tables according to one embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates invention history-based merge mode, which is reviewed as follows.

### History-Based Merge Mode Construction

The History Based Merge Mode stores some previous CU's merge candidates in a history array. For the current CU, besides the original merge mode candidate construction, it can use one or more candidates inside the history array to enrich the merge mode candidates. The details of the History-based Motion Vector Prediction can be found in JVET-K0104 (Li Zhang, et al., “CE4-related: History-based Motion Vector Prediction”, Joint Video Experts Team (JVET) of ITU-T SG 16 WP 3 and ISO/IEC JTC 1/SC 29/WG 11, 11th Meeting: Ljubljana, SI, 10-18 Jul. 2018, Document: JVET-K0104).

In HMVP, a table of HMVP candidates is maintained and updated on-the-fly. After decoding a non-affine inter-coded block, the table is updated by adding the associated motion information as a new HMVP candidate to the last entry of the table. A First-In-First-Out (FIFO) or constraint FIFO rule is applied to remove and add entries to the table. The HMVP candidates can be applied to either merge candidate list or AMVP candidate list.

A history-based MVP (HMVP) method is proposed wherein a HMVP candidate is defined as the motion information of a previously coded block. A table with multiple HMVP candidates is maintained during the encoding/decoding process. The table is emptied when a new slice is encountered. Whenever there is an inter-coded block, the associated motion information is added to the last entry of the table as a new HMVP candidate. The overall coding flow is depicted in FIG. 2, where step 210 is performed to load a table with initial HMVP candidates and to update the table with decoded motion information resulted from step 220.

In the case that the table size S is set to be 16, up to 16 HMVP candidates may be added to the table. If there are more than 16 HMVP candidates from the previously coded blocks, a First-In-First-Out (FIFO) rule is applied so that the table always contains the latest previously coded 16 motion candidates. FIG. 3A illustrates an example where the FIFO rule is applied to remove a HMVP candidate and add a new one to the table used in the proposed method.

To further improve the coding efficiency, a constrained FIFO rule is introduced where, when inserting a HMVP to the table, redundancy check is firstly applied to find whether there is an identical HMVP candidate in the table. If found, the identical HMVP candidate is removed from the table and all the HMVP candidates afterwards are shifted, i.e., with indices reduced by 1. FIG. 3B illustrates an example of the constraint FIFO rule, where candidate NMVP₂ is found to be redundant and is removed after update.

HMVP candidates can be used in the merge candidate list construction process. All HMVP candidates from the last entry to the first entry in the table are inserted after the TMVP candidate. Pruning is applied on the HMVP candidates. Once the total number of available merge candidates reaches the signalled maximally allowed merge candidates, the merge candidate list construction process is terminated.

Similarly, HMVP candidates can also be used in the AMVP candidate list construction process. The motion vectors of the last K HMVP candidates in the table are inserted after the TMVP candidate. Only HMVP candidates with the same reference picture as the AMVP target reference picture are used to construct the AMVP candidate list. Pruning is applied on the HMVP candidates. In JVET-K0104, K is set to 4.

In addition, when the total merge candidate number is larger than or equal to 15, a truncated unary plus fixed length (with 3 bits) binarization methods is applied to code a merge index. With the total number of merge candidates denoted as N_{mrg}, the binarization method is tabulated in Table 1.

TABLE 1
Bin string of the merge index (assume N_{mrg} is 15)

| merge | | | | | | | | | | |
|---|---|---|---|---|---|---|---|---|---|---|
| index | Bin String | | | | | | | | | |
| 0 | 0 | | | | | | | | | |
| 1 | 1 | 0 | | | | | | | | |
| 2 | 1 | 1 | 0 | | | | | | | |
| . . . | | | | | | | | | | |
| 5 | 1 | 1 | 1 | 1 | 1 | 0 | | | | |
| 6 | 1 | 1 | 1 | 1 | 1 | 1 | 0 | | | |
| 7 | 1 | 1 | 1 | 1 | 1 | 1 | 1 | 0 | 0 | 0 |
| 8 | 1 | 1 | 1 | 1 | 1 | 1 | 1 | 0 | 0 | 1 |
| . . . | | | | | | | | | | |
| 14 | 1 | 1 | 1 | 1 | 1 | 1 | 1 | 1 | 1 | 1 |
| Bin | 0 | 1 | 2 | 3 | 4 | 5 | 6 | 7 | 8 | 9 |
| index | | | | | | | | | | |

In order to improve the coding efficiency of HMVP, some methods are disclosed to add more HMVP tables to increase the diversity of HMVP candidates.

### Method 1: Multi-HMVP Tables

In one embodiment, it is proposed to use more than one HMVP table generated by applying different updating rules, such as different updating frequencies. For example, one look-up table (LUT-0) is updated per CU. Another look-up table (LUT-1) is update once within 5 CUs. The HMVP table is also referred as a look-up table in this disclosure since the look-up table can be used to implement the HMVP table. According to another embodiment, the updating rule can be related to partition results associated with a CU, such as quadtree depth, binary tree depth or the number of partitions associated with the CU. For example, LUT-0 is updated only if the QT depth/BT depth/partition time of the current block is smaller than 3. LUT-1 is updated only if the QT depth/BT depth/partition time of the current block is larger than 3.

In another embodiment, it is proposed to use more than one HMVP table generated based on the difference between the to-be added motion and the motions stored in LUT, where the difference is called as MVD. For example, one motion vector is used to update LUT-0 if the absolute value of MVD between the to-be added motion and any other motions in LUT-0 are all larger than threshold, such as 0. One motion vector is used to update LUT-1 if the absolute value of MVD between the to-be added motion and any other candidates in LUT-1 are all larger than another threshold, such as 32.

In another embodiment, it is proposed to use more than one HMVP table generated based on position of a corresponding CU. For example, LUT-0 is updated only if the top-left position of to-be inserted CU's position is in 128×128 grid. LUT-1 is updated only if the top-left position of to-be inserted CU's position is in 64×64 grid.

In another embodiment, it is proposed to store not only the motion information in the LUT, but also the position of current CU. By doing so, more than one HMVP table can be created based on the position of current CU. In one embodiment, the horizontal distance or vertical distance between the to-be inserted CU and any CU having motion information stored in the HMVP table can be used to determine whether to insert the motion information. For example, one motion information (e.g. motion vector) is used to update LUT-0 if the horizontal distance or vertical distance between the to-be inserted CU and any CU having motion information stored in LUT-0 is larger than a threshold, such as 16. One motion information (e.g. motion vector) is used to update LUT-1 if the horizontal distance or vertical distance between the to-be inserted CU and any CU having motion information stored in LUT-1 is larger than another threshold, such as 64.

In another embodiment, it is proposed to create more than one HMVP table based on the sign values of MVx, and MVy. For example, 4 HMVP tables are created: LUT-0 is used to store motion vectors with sign (MVx)>=0 and sign (MVy)>=0; LUT-1 is used to store motion vectors with sign (MVx)<0 and sign (MVy)>=0; LUT-2 is used to store motion vectors with sign (MVx)>=0 and sign (MVy)>0; and LUT-3 is used to store motion vector with sign (MVx)<0 and sign (MVy)<0. For another example, 8 HMVP tables are creates for 8 kinds of sign (MVx, Mvy) pair.

In another embodiment, it is proposed to create more than one HMVP table based on CU's prediction mode. For example, 2 HMVP tables are created: LUT-0 is used to store motion vectors from merge mode and LUT-1 is used to store motion vectors from non-merge mode.

In addition, the above-mentioned embodiments can be further constrained so that if one LUT is updated, other LUTs cannot be updated. In other words, one motion information is used to update only one LUT.

In addition, the above-mentioned embodiments can be further combined. For example, LUT-0 is updated with CUs in 128×128 grid, and the motion will be inserted if it is different from any other motion in LUT-0. LUT-1 is updated with CUs in 128×128 grid, and the motion will be inserted if the MVDs between the to-be inserted motion information and any other motion information in LUT-1 are larger than a threshold, such as 64.

In another embodiment, the spatial domain multi-HMVP tables can be generated. For example, one LUT is updated within N CTUs. That is, in this LUT, only the motion information in these N CTUs can be used to update the LUT. N can be any positive integer larger than 0. In this way, motion information from cross-CTU/cross-CTU-rows can be used by referencing spatial domain multi-HMVP tables. In additional, it can be further constrained that only above M CTU row’ LUTs will be kept.

Method 2: Inserting Candidates from Multi-HMVP Tables to Merge Candidate List or AMVP MVP List

According to this method, N candidates in more than one HMVP tables can be selected to insert into the merge candidate list or AMVP MVP list. N can be any integer larger than 0.

In one embodiment, HMVP LUTs not only store the motion information, but also the left-top position of the to-be inserted CU. After that, the N candidates are selected based on the CU's position. For example, the motion information with CU's positions closest to current CU will be selected before the motion information with CU's position far away from the current CU. In another embodiment, the motion information with CU's position far away from the current CU will be selected first before the motion information with CU's position close to the current CU.

In another embodiment, the N candidates are selected based on the distance between the current CU and corresponding CUs with motion information stored in the LUT. The distances are designed according to the current CU width and height. For example, the distances between the current CU and corresponding CUs with the motion information stored in the LUT are larger than CU width or height and smaller than two times of CU width and height will be inserted first. After that, the distances between the current CU and the corresponding CUs with the motion information stored in the LUT are larger than two times of CU width or height and smaller than three times of CU width and height will be inserted.

In one embodiment, N additional HMVP LUTs are used. The candidates from M of them are added from old to new. (N-M) of them are added from new to old.

In one embodiment, more than one HMVP LUT is used. The candidates are added in an interleaving manner. For example, the newest motion in LUT-0 is added first. And then, the newest motion in LUT-1 is added. And then, the newest motion in LUT-2 is added. After that, the second newest motion in LUT-0 is added. And then, the second newest motion in LUT-1 is added. And then, the second newest motion in LUT-2 is added. For another example, K candidates in the promising LUT-A are inserted first, and then interleave to added motions from other LUTs.

In another embodiment, more than one LUT are used. The added LUT order is designed based on the current CU size. For example, 3 LUTs are used. LUT-0 is updated by motions from the CU in 16×16 grid. LUT-1 is updated by motions from the CU in 64×64 grid. When current CU's position is in 16×16 grid, candidates from LUT-0 are inserted before candidates from LUT-1.

Any of the foregoing proposed inter prediction based on multiple HMVP methods can be combined with each other. For example, Method 1 can be used with Method 2 together.

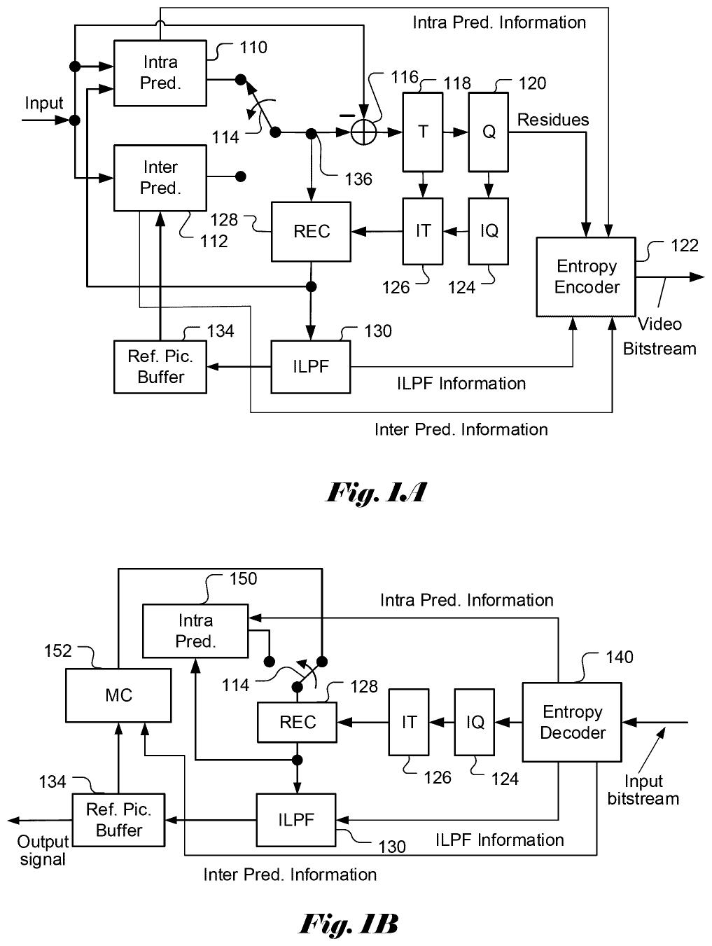

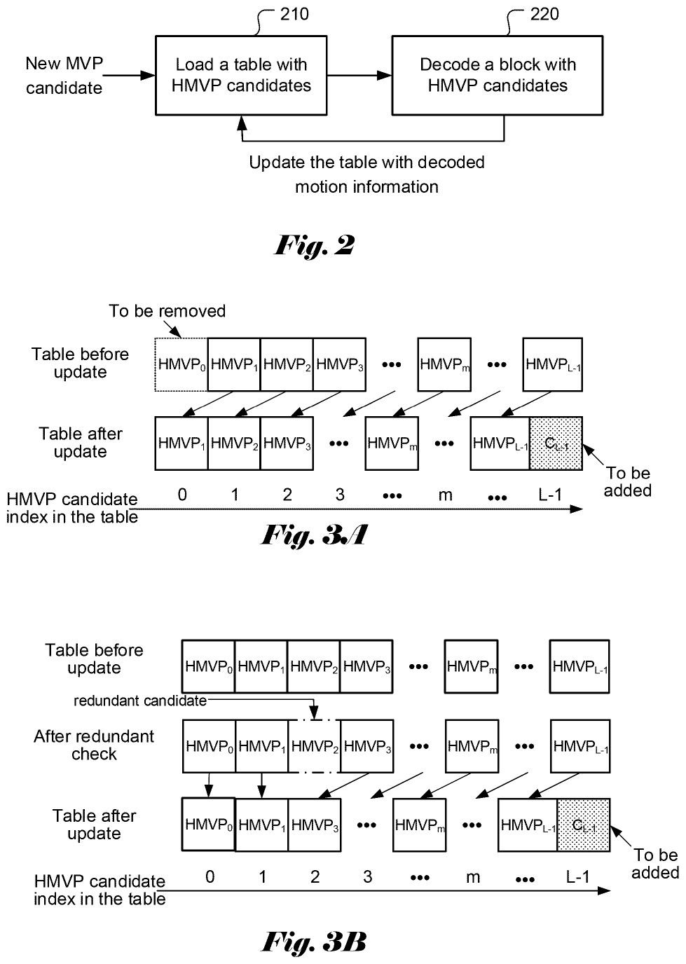

Any of the foregoing proposed inter prediction based on multiple HMVP methods can be implemented in encoders and/or decoders. For example, any of the proposed methods can be implemented in an inter coding module (e.g. MC 152 in FIG. 1B) of a decoder. Also, any of the proposed methods can be implemented in an inter coding module of an encoder (e.g. Inter Pred. 112 in FIG. 1A). Alternatively, any of the proposed methods can be implemented as one or more circuits or processors coupled to the inter/intra/prediction/entropy coding modules of the encoder and or the inter/intra/prediction/entropy coding modules of the decoder, so as to provide the information needed by the inter/intra/prediction module.

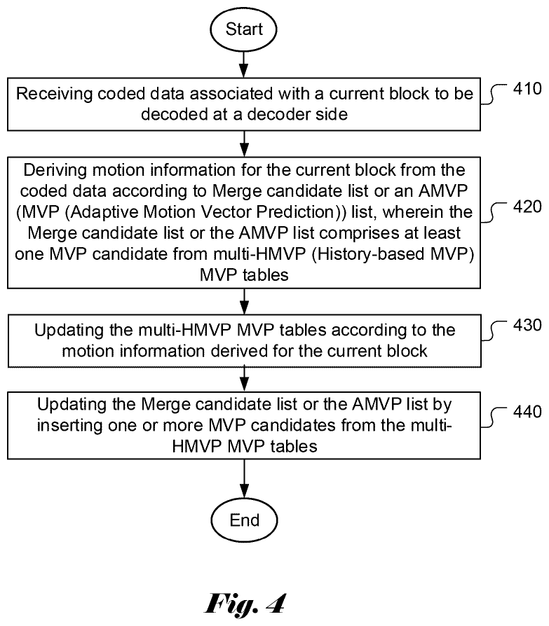

FIG. 4 illustrates a flowchart of an exemplary video decoding system that incorporates multiple History-based MVP tables according to one embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, coded data associated with a current block to be decoded at a decoder side are received in step 410. Motion information for the current block is derived from the coded data according to Merge candidate list or an AMVP (MVP (Adaptive Motion Vector Prediction)) list in step 420, wherein the Merge candidate list or the AMVP list comprises at least one MVP candidate from multi-HMVP (History-based MVP) MVP tables. The multi-HMVP MVP tables are updated according to the motion information derived for the current block in step 430. The Merge candidate list or the AMVP list is updated by inserting one or more MVP candidates from the multi-HMVP MVP tables in step 440.

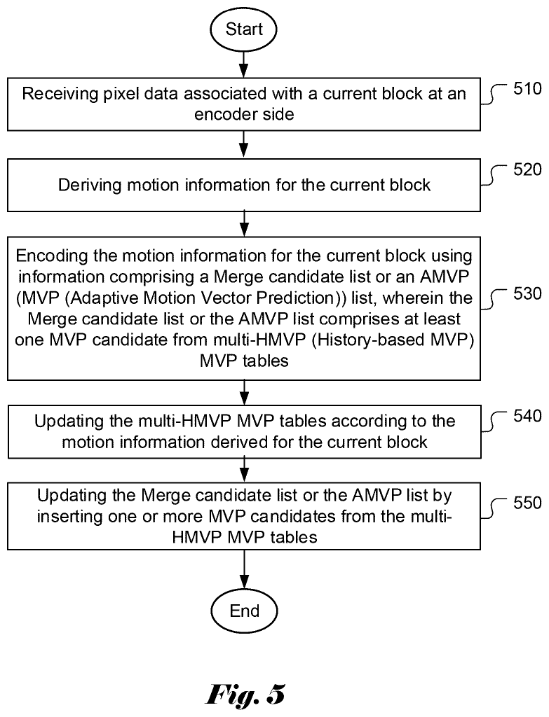

FIG. 5 illustrates a flowchart of an exemplary video encoding system that incorporates multiple History-based MVP tables according to one embodiment of the present invention. According to this method, pixel data associated with a current block are received at an encoder side in step 510. Motion information for the current block is derived in step 520. The motion information for the current block is encoded using information comprising a Merge candidate list or an AMVP (MVP (Adaptive Motion Vector Prediction)) list in step 530, wherein the Merge candidate list or the AMVP list comprises at least one MVP candidate from multi-HMVP (History-based MVP) MVP tables. The multi-HMVP MVP tables are updated according to the motion information for the current block in step 540. The Merge candidate list or the AMVP list is updated by inserting one or more MVP candidates from the multi-HMVP MVP tables in step 550.

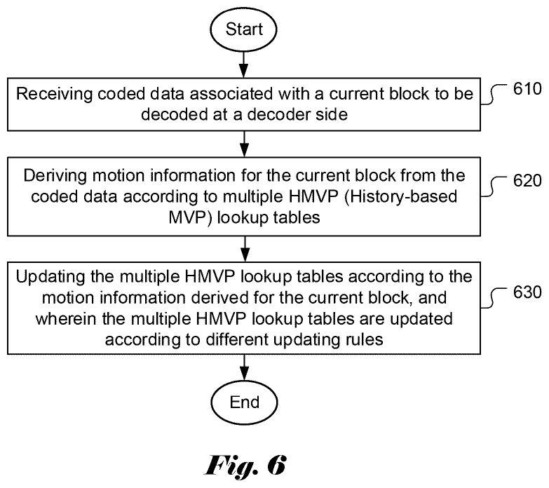

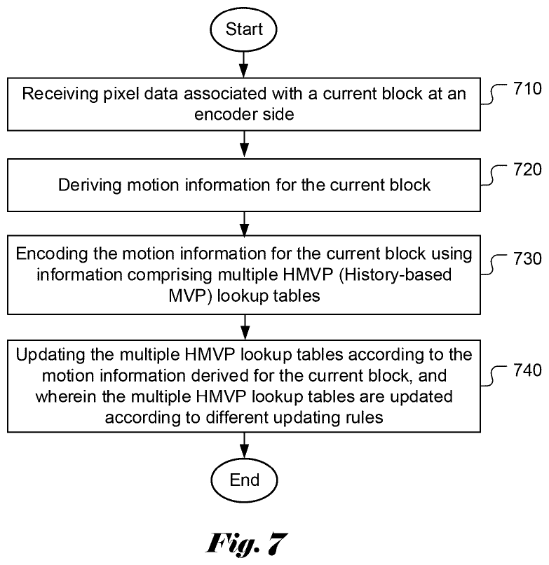

FIG. 6 illustrates a flowchart of another exemplary video decoding system that incorporates multiple History-based MVP tables according to one embodiment of the present invention. According to this method, coded data associated with a current block to be decoded at a decoder side are received in step 610. Motion information for the current block is derived from the coded data according to multiple HMVP (History-based MVP) lookup tables in step 620. The multiple HMVP lookup tables are updated according to the motion information derived for the current block, and wherein the multiple HMVP lookup tables are updated according to different updating rules in step 630.

FIG. 7 illustrates a flowchart of another exemplary video encoding system that incorporates multiple History-based MVP tables according to one embodiment of the present invention. According to this method, pixel data associated with a current block are received at an encoder side in step 710. Motion information for the current block is derived in step 720. The motion information for the current block is encoded using information comprising multiple HMVP (History-based MVP) lookup tables in step 730. The multiple HMVP lookup tables are updated according to the motion information derived for the current block, and wherein the multiple HMVP lookup tables are updated according to different updating rules in step 740.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video decoding, the method comprising:
receiving coded data associated with a current block to be decoded at a decoder side;
deriving motion information for the current block from the coded data according to Merge candidate list or an AMVP (MVP (Adaptive Motion Vector Prediction)) list, wherein the Merge candidate list or the AMVP list comprises at least one MVP candidate from multi-HMVP (History-based MVP) MVP tables;
updating the multi-HMVP MVP tables according to the motion information derived for the current block; and
updating the Merge candidate list or the AMVP list by inserting one or more MVP candidates from the multi-HMVP MVP tables.

2. The method of claim 1, wherein a position of the current block is also stored in the multi-HMVP MVP tables.

3. The method of claim 2, wherein the position of the current block corresponds to a top-left position.

4. The method of claim 2, wherein an order to insert a target MVP candidate into the Merge candidate list or the AMVP list depends on a distance between the current block and a corresponding block associated with the target MVP candidate.

5. The method of claim 4, wherein a first MVP candidate in the multi-HMVP MVP tables is selected to be inserted into the Merge candidate list or the AMVP list before a second MVP candidate if a first CU corresponding to the first MVP candidate is closer to the current block than a second CU corresponding to the second MVP candidate.

6. The method of claim 4, wherein a first MVP candidate in the multi-HMVP MVP tables is selected to be inserted into the Merge candidate list or the AMVP list before a second MVP candidate if a first CU corresponding to the first MVP candidate is farther to the current block than a second CU corresponding to the second MVP candidate.

7. The method of claim 4, wherein a first MVP candidate in the multi-HMVP MVP tables having a first distance between a first corresponding block of the first MVP candidate and the current block larger than a block width or a block height, but less than twice the block width or twice the block height is selected to be inserted into the Merge candidate list or the AMVP list first.

8. The method of claim 7, wherein a second MVP candidate in the multi-HMVP MVP tables having a second distance between a second corresponding block of the second MVP candidate and the current block larger than twice the block width or twice block height, but less than three times the block width or three times the block height is selected to be inserted into the Merge candidate list or the AMVP list second.

9. The method of claim 1, wherein multiple MVP candidates from one table of the multi-HMVP MVP tables are inserted into the Merge candidate list or the AMVP list in an order from new to old, or from old to new.

10. The method of claim 1, wherein multiple MVP candidates from the multi-HMVP MVP tables are inserted into the Merge candidate list or the AMVP list in an interleaving manner.

11. A method of video encoding, the method comprising:
receiving pixel data associated with a current block at an encoder side;
deriving motion information for the current block;
encoding the motion information for the current block using information comprising a Merge candidate list or an AMVP (MVP (Adaptive Motion Vector Prediction)) list, wherein the Merge candidate list or the AMVP list comprises at least one MVP candidate from multi-HMVP (History-based MVP) MVP tables;
updating the multi-HMVP MVP tables according to the motion information for the current block; and
updating the Merge candidate list or the AMVP list by inserting one or more MVP candidates from the multi-HMVP MVP tables.

12. A method of video decoding, the method comprising:
receiving coded data associated with a current block to be decoded at a decoder side;
deriving motion information for the current block from the coded data according to multiple HMVP (History-based MVP) lookup tables; and
updating the multiple HMVP lookup tables according to the motion information derived for the current block, and wherein the multiple HMVP lookup tables are updated according to different updating rules.

13. The method of claim 12, wherein the multiple HMVP lookup tables have different updating frequencies.

14. The method of claim 12, wherein one of the multiple HMVP lookup tables is updated according quadtree depth, binary tree depth or a number of partitions associated with the current block.

15. The method of claim 12, wherein whether a motion vector is used to update one of the multiple HMVP lookup tables depends on motion vector differences between the motion vector and motion vector candidates in said one of the multiple HMVP lookup tables.

16. The method of claim 12, wherein whether a motion vector is used to update one of the multiple HMVP lookup tables depends on a position of a corresponding block associated with the motion vector.

17. The method of claim 16, wherein the position of the corresponding block corresponds to a top-left position.

18. The method of claim 16, wherein if the position of the corresponding block is at a selected grid, the motion vector is used to update said one of the multiple HMVP lookup tables.

19. A method of video encoding, the method comprising:
receiving pixel data associated with a current block at an encoder side;
deriving motion information for the current block;
encoding the motion information for the current block using information comprising multiple HMVP (History-based MVP) lookup tables;
updating the multiple HMVP lookup tables according to the motion information derived for the current block, and wherein the multiple HMVP lookup tables are updated according to different updating rules.
